(19) United States
(12) Patent Application Publication
(10) Pub. No.: US 2014/0025366 A1
(43) Pub. Date: Jan. 23, 2014

(54) TXTVOICETRANS

(71) Applicants: Hristo Tzanev Georgiev, Walenstadt (CH); Maria Theresia Georgiev(-Good), Walenstadt (CH)

(72) Inventors: Hristo Tzanev Georgiev, Walenstadt (CH); Maria Theresia Georgiev(-Good), Walenstadt (CH)

(21) Appl. No.: 13/553,950

(22) Filed: Jul. 20, 2012

(51) Int. Cl. G06F 17/28; G10L 13/08

(52) U.S. Cl. 704/2; 704/260; 704/E13.011

(57) ABSTRACT

TXTVOICETRANS can pronounce the written word in the same language or in another language. TXTVOICETRANS is a Machine Translation computer system that can translate the source text into another language and, at the same time, pronounce the translated text, word by word, preserving fully the accent and the stress of the spoken word and the intonation of a sequence of words. The pronunciation is based on whole words. The computer system can pronounce the most used synonym of the word or the concept the translated word belongs to, instead of the translated word, displayed with the translation.

### CROSS-REFERENCES TO RELATED APPLICATIONS

Prior application (pending): application Ser. No. 13/198,392

Prior application (allowed): application Ser. No. 13/472,496

### STATEMENT REGARDING FEDERALLY SPONSORED RESEARCH OR DEVELOPMENT

There is no federally sponsored research or development.

### NAMES OF THE PARTIES TO A JOINT RESEARCH AGREEMENT

There are no parties to a joint research agreement.

### INCORPORATION-BY-REFERENCE OF MATERIAL SUBMITTED ON A COMPACT DISC OR AS A TEXT FILE VIA THE OFFICE ELECTRONIC FLUNG SYSTEM (EFS-WEB)

No material is submitted neither via EFS-WEB nor by post.

### STATEMENT REGARDING PRIOR DISCLOSURES BY THE INVENTOR OR JOINT INVENTOR

The invention was not patented or described in a printed publication in this or a foreign country or in public use or on sale in this country, more than one year prior to the date of application for patent in the United States.

### BACKGROUND OF THE INVENTION

(1) Field of the Invention

Natural Language Text Processing, Machine Translation from one language into another, Text to voice bilingual Machine Translation, that part of Artificial Intelligence that deals with Natural Language.

(2) Background Art

The existing text-to-voice systems are of the following types:
Vocabulary based only. The vocabulary based text-to-voice systems have a vocabulary. The user can type in a word and if this word is found in the vocabulary it can be pronounced either in the same language or in another language, if such choice is provided. The vocabulary based system can pronounce the word with synthetically generated voice or with natural voice only when this word is present in the vocabulary.
Text books, including electronic books, for learning a foreign language. In these books the user can select a word, a sentences or a whole portion of text and the word, the sentence or the selected portion of text will be pronounced in the same language or in another language, if such choice is provided. Text books and the electronic books can pronounce the word with synthetically generated voice or with natural voice. The position, the context of each word and of each sentence in the text book and in the electronic book is fixed, it is known. Therefore there is no need of an algorithmic procedure to find out what is the actual context of a particular word or sentence within this book. Since the context is fixed and known, the contextual meaning of each constituent word is also known and can be pronounced as such, by choosing the best synonym in this particular context for this particular word. The actual word or its meaning, expressed with a synonym or concept, can be pronounced also in another language. In these systems, there is no contextual ambiguity to resolve.
Another type of text-to-voice systems are those that pronounce directly users input, be it a word or a sentence or a short text. The users input is not previously known to the system, therefore the context of each word and of each sentence in the input text is also not known. The input language is also not precisely known to the system, it is only guessed and this system can pronounce, using a synthesized voice also any nonsense you write, because these systems have no word vocabulary, no phrases. They have syllables and phonemes and possible sequences of them, common to most languages. As a result, such systems cannot differentiate the homographs, because they do not analyse the input text to determine the part of speech, part of the sentence and meaning of each constituent word, in context. They pronounce anything, written in any language. As such, they are useless for languages that are full of homographs, like, for example, Vietnamese.
Machine Translation Systems. They are Server based and PC based. Those that are Server based can be used only by those who have Internet connection. The PC based can be used by anybody who has a personal computer at home. The Machine Translation Systems do bilingual machine translation, they translate from one language into another with certain degree of accuracy, because they translate texts not known previously to the system. Because the translated text is not known previously to the system, the system must find out the contextual meaning of each word.

There are no Machine Translation Systems that translate into the same language, with the purpose of making the text more understandable for everybody who reads it. There are no Text-to-voice bilingual Machine Translation Systems. There is one, Server based, that translates from one language into another. The translated text is turned into voice using the previously described system, as an external device, with all its shortcomings as far as the homographs are concerned.

### BRIEF SUMMARY OF THE INVENTION

Our text-to-voice system is a Machine Translation System, as described above. As such, it uses a vocabulary, a bilingual dictionary, as all Machine Translation Systems do. However, it is neither a vocabulary-to-voice system, nor text-book-to-speech system in the sense described above. As all Machine Translation Systems it translates sentences and texts not known previously to the system and our system must find out, by itself, the contextual meaning of each word in the sentence by analysing up to five consecutive/non-consecutive words at a time.

The difference between our Machine Translation System and the existing Machine Translation Systems is that ours translates the text into another language and at the same time pronounces the translated text in the target language. Our text to speech technology is based on whole words, phrases and concepts, not on phonemes and syllables, as described above. For example, our text to voice computer system will pronounce fish if one writes herring, cod, etc. words denoting fish, when the words belong to the same concept. If needed, the computer system will pronounce the most used synonym of the word instead of the actual written word, for example, if one writes blether, chat, chatter, converse, debate, gabble, gossip, jabber, patter, etc., the computer system will pronounce talk, or speak depending on context. Many individual words, such as prepositions, articles, etc. are pronounced as individual words. Many other individual words, such as names of important places or people are also pronounced as individual words.

The same method is used when translating from one language into another language. For example, if one writes acquiesce, assent, come to terms, comply, concede, condescend, etc. in English, our computer system will translate stimmen, in German, and pronounce stimmen. Our computer system can pronounce the translation in any other language, as required.

On the other hand, when our computer system translates from German into English, if the German word belongs to the semantic group denoting entry, entrance, opening, door and ends with -öffnung, the computer system will pronounce opening, if the word ends with -tor or -tür, the computer system will pronounce door, if the word ends with -loch, the computer system will pronounce hole, if the word ends with -fenster, the computer system will pronounce window, etc. The same applies when the computer system translates from German into any other language, the translated word can be seen, in writing, and heard at the same time. Often the written word and the spoken word do not coincide, because our text to voice translation is not based on reading aloud what is written, it is based on pronouncing what is meant.

Our computer system pronounces only words or meanings that exist in the language and does that immediately, with the translation. The accent and the stress of the spoken word is fully preserved, depending on context and meaning. The intonation of the interrogative sentences is also taken into consideration.

A Machine Translation System needs a compiler to compile the source code and to turn it into executable file. A compiler has a memory limit, it cannot compile the source code if it exceeds this limit. A Machine Translation System with half a million English word entries and over two million German word entries needs enormous compiler memory in order to compile the source code containing voice instructions for each word entry. Therefore, our invention proposes a mixed approach, to pronounce certain words as they are written, such as Auxiliary Words, names of people and places, to pronounce the most used synonym of a word instead of the word itself and, if appropriate, to pronounce the concept of the word, instead of the written word.

With this innovation we solve not only the compiler memory problem, we solve also a major educational, language learning problem, by providing simplified and understandable Machine Translation in the same language or in another language, accompanied with voice translation. In our first invention, cited above, we propose a text-to-video Machine Translation System, based on the same principles as the text-to-voice, as described here. Our intention with these innovations is to combine both voice and video in one Machine Translation System, whereby the user will see the written translation, will hear it and will see, at the same time, in the form of motion pictures, what it means. This is a powerful educational method and it solves the homograph problem, which the vocabulary based method cannot solve, it solves the text book problem, because it can process and turn into voice any text not only the text contained in the text book.

Our text to voice computer system can be used in other fields. For example, when one cannot see the translation or when one cannot use, for some reason, an external device to read aloud the translation, in such situations as communication between ground and pilot.

The innovation can be used for simultaneous text to voice machine translation in such assemblies like the United Nations, where each delegate listens the translation in ones own language, provided that the text is typed first or the voice is translated into text first (such computer systems already exist) and then the same text is heard spoken in another language, or in the language of ones choice.

### BRIEF DESCRIPTION OF THE SEVERAL VIEWS OF THE DRAWING(S)

There are no drawings.

### DETAILED DESCRIPTION OF THE INVENTION

The programming language used in the invention is C/C++.

Any text-processing system needs a word-list, called a Dictionary or Lexicon or lately called ‘lingware’. For example, the English word book, the German word Buchständer, the French word abolition are presented in our respective language Dictionary with its basic form and with its wordforms:

| English | German | French |
|---|---|---|
| book | Buchständer | abolition |
| books | Buchständern | abolitions |
| booked | Buchständers | |
| booker | | |
| bookers | | |
| booking | | |

Such a presentation, as shown above is useless, without morphological, grammatical, syntactical, semantical, etc. information needed for each word in text processing. Therefore, we have to code this information and attach it to each word entry in our database in the following way:

| English | German | French |
|---|---|---|
| adventurer = N | buchständer = N | abolition = N |
| abandon = V | abändern = V | abaisser = V |
| abroad = D | abends = D | abondamment = D |

where = means “is a”, N means noun, V means verb, D means adverb, etc. for each part of speech.

Many words in the language are ambiguous, as part of speech, for example. Therefore we will have to code this ambiguity, so that our computer system knows that a certain word entry is ambiguous. By knowing that the word is ambiguous, the computer system triggers a rule to disambiguate the word, in context. We code the ambiguity of each ambiguous word, as part of speech, in the following way:

| English | German | French |
|---|---|---|
| abstract = Z/N/A | plumpen = Z/N/A | annexe = Z/N |

where Z/N or Z/N/A verb or noun, verb or noun or adjective. This is what the word can be, when the word is not in a text. When the word is in a text, it can be only one thing, either a verb or a noun or an adjective. What the word actually is, in context, is determined by rules in the computer system, which we will describe further below, when we come to programming the rules.

For detailed text analysis aimed at understanding the meaning of the word and the meaning of the entire sentence, it is not enough to say what part of speech the word is. We must also say what the word means. We do that the following way:

| English | German | French |
|---|---|---|
| adventurer = N[H] | buchständer = N[M] | abolition = N[F] |
| adventuress = N[HF] | plumpen = Z/N[F]/A | aboutement = N[M] |
| borneo = N[N] | examen = N[U] | aboulique = N[0]/A |
| come = u[i] | abscheu = N[0] | annexe = Z/N[F] |
| tonsillitis = N[q] | ausgang = N[óM] | |

where H means human being, i means irregular, 0 means no information attached, M means Masculine, F means Feminine, U means neuter, N means,, name,,, q means illness, ó means entrance, etc. The square brackets are used to enclose, within them, the additional information about the part of speech of this particular word. The computer system reads this information in order to understand the role and the meaning of the word in context.

An important grammatical information about the Noun is its singular or plural.

In our Dictionary, as a rule, the Nouns are registered with their singular form. The plural form is recognized automatically, by a rule written in programming language. This rule can recognize automatically only the regular Verbs and Nouns (those Verbs and Nouns that form their plural or their entire paradigm according to a well defined rule, applicable to most Verbs or Nouns).

To cut it short, we have described in great detail what we do with the irregular verbs or nouns in a recent publication (see the quoted literature).

In the same publication we have described all types of ambiguity and how we resolve this ambiguity, in context.

We have described in our book “Language Engineering” how the machine translation computer system works. We have described in sufficient detail our morphological, grammatical, syntactical and semantical analysis in our previous patent applications and in a considerable number of publications. We have developed many software products for text analysis. This invention would not have been possible without these software products. Therefore we will skip that part of the invention, what is already made public by us and will concentrate on how the computer system turns the written word into a spoken word. Having enabled the computer system to recognize the written words morphologically, grammatically, syntactically and semantically and to resolve all types of ambiguity in the same language, things already known how to do and described by us and others working in the same field, we can proceed, successfully, to that stage, when the computer system will turn the written word into a spoken word, To do that, we use the following rule, in a case.

We can include in the above case the instruction
if (type==‘?’) {//if the sentence is interrogative
   and list all words that must have interrogative intonation in the sentence, by providing *.mp3 file with the correct interrogative pronunciation of the word when used in an interrogative sentence.

This was the first part of our invention, when the computer system speaks the written word in the same language. Our novelty is:
the computer system does not synthesize the word on the basis of its constituent phonemes or syllables;
the computer system pronounces the whole word, as one unit;
the computer system preserves the accent and the stress of the spoken word;
The accent and the stress of the spoken word may depend on whether the word is used as an adjective or as a verb or other part of speech. For example, the word “absent” has different stress, it depends whether it is used as an adjective or as a verb, in context. Our computer system recognizes the part of speech and the meaning of the word, in context, and chooses the correct pronunciation.
the computer system preserves the intonation in an interrogative sentence.

Having enabled the computer system to translate from one language into another language, in writing, a thing already known, described and put in practice by us and others working in the same field, it is quite simple to make the same computer system speak the translated words, one after the other, as they follow.

In our case, the written translation of the source (input) word in another language is not necessarily connected to the spoken translation of this word in the target (output) language. The spoken translation can be the same as the written translation or it can be different, but with the same meaning. We can choose to substitute the written translation with an appropriate spoken synonym to facilitate language acquisition or better understanding what was meant, by providing an alternative, spoken synonym or concept.

We can use a concept, when we do not want to differentiate too much, for example, we can use illness) to cover all types of illnesses, in such sentences as “He has cancer”, to make the computer system translate “cancer”, in writing, but say “He is ill” and speak it in another language.

case 160:

```
//part of our German-English text-to-voice machine translation
// when we have to turn the written word into spoken word
// in another (target) language
// listing all auxiliary and other individual German words
// and providing English spoken word for their translation
// see the examples provided below
        if (!stricmp(wrd->inword, “ein”) ||
        !stricmp(wrd->inword, “eine”) ||
        !stricmp(wrd->inword, “man”) ||
        !stricmp(wrd->inword, “eins”)) {
// the above instruction means if compare the word “ein”,
// “eine”, “man” or “eines”
// all instructions below starting with
// !stricmp(wrd->inword, . . . and the word, as shown
// instruct the computer system to identify the German word in
// the text
          (void)system(“one.mp3”);
// the instruction (void)system(“one.mp3”);
// instructs the computer system to call the file
// “one.mp3”
// and play it
// the same instruction is used for each word,
// by naming the *.mp3 voice file
        Sleep(1100);
// sleep (measured time);
        }
          if (!stricmp(wrd->inword, “einen”) ||
            !stricmp(wrd->inword, “einer”) ||
              !stricmp(wrd->inword, “eines”) ||
            !stricmp(wrd->inword, “einem”)) {
          (void)system(“a.mp3”);
        Sleep(800);
// sleep (measured time);
// instructs the computer system to wait while the word is
// pronounced
// etc. for all sleep instructions, the number depends on word
// length
        }
// etc. for all German individual words and their voice
// equivalent in
// English or in any other language
// note that by replacing the voice file with the respective
// French, Russian, etc. voice file for this particular
// translation of the German word, we can translate into any //
other foreign language however, each foreign language will //
need own *.cpp file with the same case
          if (!stricmp(wrd->inword, “das”) ||
            !stricmp(wrd->inword, “der”)
              || !stricmp(wrd->inword, “die”)) {
          (void)system(“the.mp3”);
        Sleep(800);
        }
          if (!stricmp(wrd->inword, “ab”)) {
          (void)system(“from.mp3”);
        Sleep(900);
        }
          if (!stricmp(wrd->inword, “an”)) {
          (void)system(“at.mp3”);
        Sleep(900);
        }
          if (!stricmp(wrd->inword, “auf”)) {
          (void)system(“on.mp3”);
        Sleep(800);
        }
// Auxilliary verbs
          if (!stricmp(wrd->inword, “bin”)) {
          (void)system(“am.mp3”);
        Sleep(1200);
        }
          if (!stricmp(wrd->inword, “bist”) ||
        !stricmp(wrd->inword, “seid”) ||
                !stricmp(wrd->inword, “seien”) ||
        !stricmp(wrd->inword, “seiest”) ||
                !stricmp(wrd->inword, “sind”)) {
          (void)system (“are.mp3”);
        Sleep(1100);
        }
          if (!stricmp(wrd->inword, “ist”)) {
          (void)system(“is.mp3”);
        Sleep(700);
        }
          if (!stricmp(wrd->inword, “sei”)) {
          (void)system(“be.mp3”);
        Sleep(800);
        } // etc. auxiliary verbs
// frequent words
        if (!stricmp(wrd->inword, “allein”)) {
                (void)system(“alone.mp3”); Sleep(1100);
        if (!stricmp(wrd->inword, “also”)) {
                (void)system(“so.mp3”); Sleep(1100);
        if (!stricmp(wrd->inword, “alt”)) {
                (void)system(“old.mp3”); Sleep(1000);
        if (!stricmp(wrd->inword, “auch”)) {
                (void)system(“also.mp3”); Sleep(1100);
        if (!stricmp(wrd->inword, “beide”)) {
                (void)system(“both.mp3”); Sleep(1000);
        if (!stricmp(wrd->inword, “beispiel”)) {
                (void)system(“example.mp3”);
Sleep(1400);
// etc. for all German individual words and their voice
// equivalent in English
// start synonyms or concepts as English translations
// adjectives
    if (wrd->syn == ‘A’ || wrd->esyn == ‘A’) {
  if (wrd->E.W.damage == 1 && wrd->syn != N_SYN) {
          (void)system(“damaged.mp3”);
        Sleep(1500);
  }
  if (wrd->E.W.no_info == 1) {
// do nothing
    }
  }
// etc. adjectives, their synonyms or concepts
// nouns
  if ((wrd->syn == ‘N’ || wrd->esyn == ‘N’) &&
      (wrd->syn != A_SYN || (wrd->syn != V_SYN))) {
  if (wrd->E.W.sport == 1 && wrd->E.W.human == 1 &&
          wrd->numb == 0) {
            (void)system(“sportsman.mp3”);
        Sleep(1300);
        }
  if (wrd->E.W.sport ==1 && wrd->E.W.human == 1 &&
          wrd->numb == 1) {
            (void)system(“sportsmen.mp3”);
        Sleep(1400);
        }
  if (wrd->E.W.entrance == 1 && wrd->numb == 0 &&
        (isflex(wrd->inword, wrd->wl, “tor”) ||
        isflex(wrd->inword, wrd->wl, “tur”))) {
// by combining a concept with word ending, we can specify
// what kind of entrance we mean, in this case it is a door
            (void)system(“door.mp3”);
        Sleep(1000);
  }
  if (wrd->E.W.entrance == 1 && wrd->numb == 0 &&
        !isflex(wrd->inword, wrd->wl, “tor”) &&
        !isflex(wrd->inword, wrd->wl, “tur”)) {
            (void)system(“entrance.mp3”);
        Sleep(1500);
  }
// etc. nouns
// for the Verbs proper
  if (wrd->E.W.increase == 1 && wrd->syn != N_SYN &&
      wrd->tense != T_PAST
  && wrd->particip_flag != 1 && wrd->person != 3) {
            (void)system(“increase.mp3”);
          Sleep(1700);
  }
  if (wrd->E.W.increase == 1) {
        if (wrd->syn != N_SYN && wrd->tense != T_PAST &&
          wrd->particip_flag != 1 && wrd->person == 3) {
            (void)system(“increases.mp3”);
          Sleep(1800);
        }
  }
  if (wrd->E.W.increase == 1) {
if (wrd->tense == T_PAST || wrd->particip_flag == 1) {
            (void)system(“increased.mp3”);
          Sleep(1800);
        }
  }
  if (wrd->E.W.put == 1) {
  if (wrd->person != 3 && wrd->tense ==T_PRESENT ||
  wrd->tense == T_PAST || wrd->particip_flag == 1) {
            (void)system(“put.mp3”);
          Sleep(1100);
        }
  }
  if (wrd->E.W.put ==1 && wrd->syn != N_SYN &&
    wrd->tense != T_PAST &&
  wrd->tense == T_PRESENT && wrd->particip_flag != 1 &&
        wrd->person == 3) {
            (void)system(“puts.mp3”);
          Sleep(1100);
  }
  if (wrd->E.W.drink == 1 && wrd->syn != N_SYN &&
        wrd->tense == T_PRESENT &&
        wrd->tense != T_PAST && wrd->person != 3) {
            (void)system(“drink.mp3”);
          Sleep(1500);
  }
  if (wrd->E.W.drink == 1 && wrd->syn != N_SYN &&
    wrd->tense !== T_PAST && wrd->particip_flag != 1 &&
        wrd->person == 3) {
            (void)system(“drinks.mp3”);
          Sleep(1600);
  }
  if (wrd->E.W.drink == 1 && wrd->syn != N_SYN &&
  wrd->tense = T_PAST && wrd->particip_flag != 1) {
            (void)system(“drank.mp3”);
          Sleep(1200);
  }
  if (wrd->E.W.drink == 1 && wrd->syn != N_SYN &&
        wrd->particip_flag == 1) {
            (void)system(“drunk.mp3”);
          Sleep(1200);
            system(“taskkill /IM wmplayer.exe /F”);
  }
// end verbs
    } // end case
          i = mpos; continue;
// in an *.h file we place the following instruction for this
// rule
{“[XPQT#&BGgK?JDdMNnRSOoMZVAaEFhueCcxYUIHèéçÜàüä£¢]”, NULL, 160},
// listing all codes of part of speech used in our computer
// system
```

We can include in the above case the instruction
if (type==‘?’) {//if the sentence is interrogative
   and list all words that must have interrogative intonation at the end of the sentence, by providing *.mp3 file with the correct interrogative pronunciation of the word when used in an interrogative sentence.

This was the second part of our invention, when the word written in one language is spoken in another language simultaneously with its written translation. Novelty:
the computer system does not synthesize the translated word on the basis of its constituent phonemes or syllables;
the computer system pronounces the translated word as a whole word, as one unit;
the computer system preserves the accent and the stress of the translated spoken word;
The accent and the stress of the spoken word may depend on whether the word is used as an adjective or as a verb or other part of speech. For example, the word “absent” has different stress, it depends whether it is used as an adjective or as a verb, in context. Our computer system recognizes the part of speech and the meaning of the word, in context, and chooses the correct pronunciation.
the computer system preserves the intonation in an interrogative sentence.

As a result of the instructions above and all other instructions in the computer system, which we have not listed, such sentences as

We have a dog.
Have we a dog?

Will be spoken with the correct accent, word stress and interrogative intonation in English or German or in any other language.

We hope, that these examples are sufficient. The computer system will translate and speak any input text.

As all other machine translation computer system, ours is not perfect too. Our translation is not always correct. A computer system of our magnitude has hundreds of rules to resolve the difficulties, mentioned earlier, in order to produce accurate output. There are hundreds, even thousands of exceptions from each of these rules. It is a great challenge to find the exceptions from each rule, in context, and to program these exceptions. That makes each computer system unique in its performance. In Natural Language Processing, every computer system is inevitably bound to produce, occasionally, wrong analysis of the sentence, to have some errors in the analysis of the text. The programmer discovers these errors during the tests and amends the existing rule or adds a new rule to correct them. Often, the slightest change of a rule in one place, to correct an existing performance error, can lead to unexpected error(s) in another place, where the computer system has performed, hitherto, correctly. Therefore the accuracy of Natural Language text analysis is the major challenge and the major argument when comparing similar products.

1. A computer-implemented method for single language Text-to-Voice Machine Translation of Natural Language sentences and texts, comprising the steps of:
(a) a computer processor, linked to user, who types in a written text, sentence or sentences, with a request this written text to be translated and spoken into the same language,
wherein the written text, is a Natural Language text, orthographically and grammatically correct,
wherein the Natural Language text is not previously known to the computer processor, it is arbitrarily chosen or newly written, it is not a text book, electronic book, exercise book, etc., where the text is fixed and known to the computer processor,
if the input text is English, to translate it into plain English, and to speak the translated text, word by word, loud and clear, in English,
if the input text is German, to translate it into simple German, and to speak the translated text, word by word, loud and clear, in German,
if the input text is in some other language, to translate it into simple language, in the same language and to speak the translated text, word by word, loud and clear, in this other language,
whereas plain or simple language is a non-idiomatic, more common, more widely used and unambiguous language,
wherein the spoken word is pronounced with its natural accent and stress, as one unit,
with non-synthetic, human voice,
wherein the spoken word can be replaced by more widely used synonym,
whereas such words as “momentary, temporal, fleeting, short-term”, etc. will be replaced with the word “brief” and the word “brief” will be pronounced,
wherein the spoken word can be replaced by a concept,
whereas such words as “confiscate, forfeit, impound, lay hands on, seize, nationalize”, etc. will be replaced with the word “take” and the word “take” will be pronounced,
if the word has homographs, the homograph is pronounced with its due stress,
whereas such words as “àbsent, absènt, àcces, accèss, àccent, accènt, réfuse, refúse”, etc. will be pronounced with the correct word stress, depending on context,
if the written word has other meanings, the contextual meaning is displayed and pronounced,
whereas the word “tried” will be replaced with the word “ate”, if it is meant trying food,
whereas the word “tried” will be replaced with the word “smoked”, if it is meant trying a cigarette,
if the word is part of a fixed or idiomatic phrase, the whole phrase is pronounced, as one unit,
if the fixed or idiomatic phrase has other synonyms, the most typical synonym is displayed and pronounced,
if the phrase can be substituted with one word, this word is displayed and pronounced,
whereas such phrase as “give a promise”, will be replaced with “promise”,
such phrase as “get the knack of” will be replaced with “master”,
such phrase as “go in for sport” will be replaced with “train”, etc.,
if the phrase is an interrogative phrase, it is pronounced with its correct intonation,
such as isn't it?, can't we?, have you?, don't you?, not at all, etc.,
wherein the pronunciation of a word or of a phrase is contained in a previously recorded voice file,
(b) the computer processor reads the user's written input, analyses it, up to five successive and non-successive words, word by word, sentence after sentence, in order to determine the morphological, phraseological, grammatical, syntactical and semantical information contained in the sentence; and
(c) the computer processor displays the simplified sentence and pronounces it, word by word or by phrase, as needed, by triggering on the respective voice vile, contained in the database,
wherein the computer processor calls an external device, resident in the Operating System, to play the voice file; and
(d) according to claim 1, the computer based software application is a computer software process for analysing the text, sentence after sentence, and displaying, in written and vocal form, each sentence, as an adequate variant of the meaning of the source sentence,

2. A computer-implemented method for bilingual Text-to-Voice Machine Translation of Natural Language sentences and texts, comprising the steps of:
(b) a computer processor, linked to user, who types in a written text, sentence or sentences, with a request this written text to be translated and spoken into another language,
wherein the written source text, is a Natural Language text, orthographically and grammatically correct,
wherein the Natural Language text is not previously known to the computer processor, it is arbitrarily chosen or newly written, it is not a text book, electronic book, exercise book, etc., where the text is fixed and known to the computer processor,
if the input text is English, to translate it into German, and to speak the translated text, word by word, loud and clear, in German,
if the input text is German, to translate it into English, and to speak the translated text, word by word, loud and clear, in English,
if the input text is in some other language, to translate it into the desired language and to speak the translated text, word by word, loud and clear, in this other, desired, language,
wherein the translated spoken word is pronounced with its natural accent and stress, as one unit, with non-synthetic, human voice,
wherein the translated spoken word can be replaced by more widely used synonym,
whereas such source words as “momentary, temporal, fleeting, short-term”, etc. will be replaced with the target word “brief” and the word “brief” will be pronounced in the target language,
wherein the spoken word can be replaced by a concept,
whereas such source words as “confiscate, forfeit, impound, lay hands on, seize, capture, nationalize”, etc. will be replaced with the target word “take” and the word “take” will be pronounced in the target language,
if the word has homographs, the homograph is disambiguated by the computer processor,
whereas such words as “àbsent, absènt, àcces, accèss, àccent, accènt, réfuse, refúse”, etc. will be disambiguated, translated and pronounced in the target language,
if the written word has other meanings, the word is disambiguated by the computer processor, translated and pronounced in the target language,
whereas the source word “tried” will be replaced with the target word “ate”, if it is meant trying food,
whereas the source word “tried” will be replaced with the target word “smoked”, if it is meant trying a cigarette,
if the source word is part of a fixed or idiomatic phrase, the whole phrase is translated and pronounced in the target language,
wherein the pronunciation of a word or of a phrase is contained in a previously recorded voice file,
(b) the computer processor reads the user's written input, analyses it, up to five successive and non-successive words, word by word, sentence after sentence, in order to determine the morphological, phraseological, grammatical, syntactical and semantical information contained in the sentence; and
(c) the computer processor translates user's written input into another language, called target language, displays the translation and pronounces it, word by word or by phrase, as needed, in natural, human voice, by triggering on the respective voice vile, contained in the database,
wherein the computer processor calls an external device, resident in the Operating System, to play the voice file,
whereas the whole word or the whole phrase is pronounced as one unit; and
(d) according to claim 1, the computer based software application is a computer software process for analysing the input text, sentence after sentence, and translating it, in written and vocal form, into the target language,

3. (canceled)

4. (canceled)
